(19) United States
(12) Patent Application Publication
(10) Pub. No.: US 2007/0283401 A1
(43) Pub. Date: Dec. 6, 2007

(54) Method for real-time identification and diagnosis of video network problems for digital cable and IPTV service providers

(76) Inventors: Minkyu Lee, Ringoes, NJ (US); Wonsuck Lee, Basking Ridge, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/444,347

(22) Filed: May 31, 2006

(51) Int. Cl. H04N 7/173

(52) U.S. Cl. 725/107; 725/105

(57) ABSTRACT

A method for identifying video network problems for digital cable and IPTV (Internet Protocol Television) service providers based on real-time on-line video quality monitoring by customers. A video quality problem reporting button is provided on each customer's set-top box and/or on a remote control unit therefor, which is used by the customer to report a video quality degradation problem to the service provider. Based on an aggregation of video quality problem reports by a plurality of customers, and based on geographical and topological information regarding these customers in connection with knowledge of the network topology, a network management system of the service provider advantageously identifies, locates, and potentially diagnoses a network problem.

### CROSS-REFERENCE TO RELATED APPLICATION

The present application is related to co-pending U.S. patent application Ser. No. ______, “Method And Apparatus For Performing Real-Time On-Line Video Quality Monitoring For Digital Cable And IPTV Services,” filed by M. Lee and W. Lee on even date herewith and commonly assigned to the assignee of the present invention.

### FIELD OF THE INVENTION

The present invention relates generally to the field of digital cable and IPTV (Internet Protocol Television) services and more particularly to a method for identifying network problems associated with video content delivery services based on real-time on-line video quality monitoring therefor.

### BACKGROUND OF THE INVENTION

Today's communication networks continue to grow in size—in particular, in geographical coverage, information capacity, number of end-users and in their bandwidth demands. Complexities and heterogeneities associated with network operation and management systems are greater than ever and will be likely to substantially increase in the future. In certain aspects, service quality degradation or outage is inescapable from a service provider's (i.e., a network operator's) perspective, and hence, maintaining an overall high quality of service is as important as the prevention of network problems. Therefore, any faults which occur within a service provider's network—whether they be catastrophic ones which eliminate service to all or to a subset of customers, or whether they merely result in reduced quality to all or to a subset of customers—must be found efficiently and diagnosed as quickly as possible.

In particular, emerging data communication and networking technologies based on the well-known Internet Protocol (IP) offer greater availability of broadband access to businesses and homes than traditional techniques. This widely deployed broadband access offers many diversified and high quality video services to users. Delivering video over IP networks, such as IPTV (Internet Protocol Television) and enhanced digital cable, becomes an increasingly attractive solution to service providers as part of their combined product offerings of voice, data, and video.

Unlike, for example, traditional narrow band voice services or TCP protocol based data services, consumers' tolerance for poor quality video is limited as a result of the human visual system's powerful information processing capability. As such, the accurate monitoring of video quality is critical to the service provider's business. In particular, by monitoring video service quality in real time (i.e., as they are being provided), service providers can effectively prevent any further service degradation (when such degradation has been identified) and can, hopefully, solve any quality problems as soon as they occur.

In normal network operation, IP networks are subject to variety of possible impairments. These include, for example, packet loss and delay jitter. Although the ultimate goal of an IPTV service provider is to devise IP networks which deliver video of high and consistent quality, it is almost impractical to achieve such a guarantee given the nature of IP networks, despite the service provider's best efforts to maximize transmission quality. Thus, a continuous monitoring of the quality of transmitted video to the individual customer becomes the next best alternative.

In order to provide high quality service, a service provider may deploy a sophisticated automated tool that can perform probing at various points within the network in order to find and locate the source of a network problem, which can, in turn, trigger any necessary diagnosis and repair steps. However, the process of probing a network is a difficult task because the probing tool needs to probe the right network entities at the right times in order to be scalable within an ever growing network, and must further minimize any resultant overhead from probing within an already busy network system. Thus, the importance of prompt, efficient, and scalable probing techniques cannot be overemphasized in the context of the typically massive network systems which provide, for example, digital cable or IPTV video services, and which support very diverse end users' expectations.

In the above-referenced co-pending U.S. patent application, “Method And Apparatus For Performing Real-Time On-Line Video Quality Monitoring For Digital Cable And IPTV Services,” filed by M. Lee and W. Lee on even date herewith and commonly assigned to the assignee of the present invention, a method for providing real-time on-line video quality problem information to a service provider which eliminates the need for such automated probing tools is described. (Co-pending U.S. patent application, “Method And Apparatus For Performing Real-Time On-Line Video Quality Monitoring For Digital Cable And IPTV Services” is hereby incorporated by reference as if fully set forth herein.) In particular, the method described therein recognized that, since the assessment of video quality is highly subjective in nature, the most accurate and useful method for performing video quality assessment is not only to make use of a human subject, but, moreover, to employ the customer himself or herself in real-time.

More specifically, an illustrative embodiment of the method described in “Method And Apparatus For Performing Real-Time On-Line Video Quality Monitoring For Digital Cable And IPTV Services” advantageously permits the real-time on-line reporting of a problem with the video quality, as perceived by the customer himself or herself, by, for example, simply pushing a button on either a set-top box or a remote control unit. Given such a method for providing real-time on-line subjective problem reporting, however, it would also be advantageous for a service provider to be able to make advantageous use of such capability in its own efforts to identify and diagnose problems in its network.

### SUMMARY OF THE INVENTION

We have recognized that, when customers of a video service provider have the capability of reporting video quality problems on-line in real-time with use of an effective technique such as is described in “Method And Apparatus For Performing Real-Time On-Line Video Quality Monitoring For Digital Cable And IPTV Services,” the service provider advantageously has a readily available mechanism to identify and diagnose problems within the video service provider's network. In particular, and in accordance with an illustrative embodiment of the present invention, a service provider which offers such real-time on-line video problem reporting capability may advantageously aggregate information regarding reported video quality problems received from one or more of its customers in order to identify, locate, and potentially diagnose problems in the network.

For example, if a given type of video quality problem is reported in accordance with the principles of the present invention by a plural number of customers, the service provider will be able to advantageously determine that the problem is unlikely to be located at the individual customers' premises, but, rather, is located within the service provider's network. On the other hand, if a video quality problem is reported in accordance with the principles of the present invention by a single customer only, it is more likely that the problem is either physically located at the customers' premises or otherwise associated with the given customer's individual service. Thus, by recognizing the existence of video quality problem reports from a plurality of customers in accordance with an illustrative embodiment of the present invention, and by then analyzing those customers' geographical and topological information with respect to the service provider's network, the service provider may advantageously identify, locate, and potentially diagnose the source of the problem.

In particular, the present invention provides a method for use by a video service provider for identifying a network problem in a video network used by said video service provider to transmit video signals to customers thereof, the method comprising the steps of (a) receiving, from one or more of said customers of said video service provider, one or more corresponding real-time on-line reports of a video quality problem with one of said video signals, the one of said video signals having been received from said service provider at one or more customer premises and the video quality problem therewith being that said one of said video signals is of insufficient quality, each of said customer premises having located thereat a video display control apparatus for receiving and displaying said video signal, the real-time on-line reports of said video quality problem each having been initiated by a corresponding one of said customers with use of a user interface associated with said corresponding video display control apparatus; and (b) identifying a potential location in said video network of a where a potential network problem exists based on (i) said one or more received real-time on-line reports of said video quality problem with said one of said video signals, and (ii) information relating said one or more of said customers to corresponding geographical and/or topological locations within said video network.

### BRIEF DESCRIPTION OF THE DRAWINGS

FIG. 1 shows an example of a set-top box for receiving IPTV video signals and reporting video quality problems in accordance with an illustrative embodiment of the present invention.

FIG. 2 shows an example of a remote control for use with a set-top box for receiving IPTV video signals and reporting video quality problems in accordance with an illustrative embodiment of the present invention.

FIG. 3 shows a sample “question tree” flowchart of a method for performing video quality problem troubleshooting in accordance with an illustrative embodiment of the present invention.

FIG. 4 shows a flowchart of a sample method for identifying and diagnosing a video network problem in accordance with an illustrative embodiment of the present invention.

### DETAILED DESCRIPTION OF THE PREFERRED EMBODIMENTS

### Illustrative Video Problem Reporting Process

In accordance with an illustrative embodiment of the present invention, a button is installed on a customer's set-top box and/or remote control unit therefor, the activation (e.g., pressing) of which may be advantageously used to report a video quality degradation problem to service providers or their network management system. Illustratively, a single push of the button initiates the reporting process, indicating that the customer is experiencing a video quality problem. In accordance with some illustrative embodiments of the present invention, and as described below, a few extra steps can be advantageously used to refine the problem definition with the help of the customer, to thereby obtain a subjective opinion of the nature of the problem. For example, the severity of the video degradation problem may, for example, be indicated by the customer based on, for example, a number of times the aforementioned button is pushed, and may respond interactively to questions and or suggestions presented by the service provider on the video screen

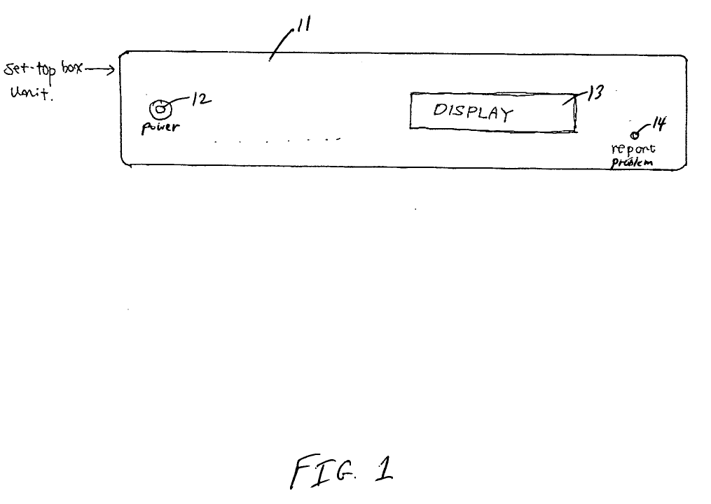

FIG. 1 shows an example of a set-top box for receiving IPTV video signals reporting video quality problems in accordance with an illustrative embodiment of the present invention. The figure shows set-top box 11 having power button 12, display 13, and, in accordance with the illustrative embodiment of the present invention, video quality problem reporting button 14. Other buttons and other features which may be present on set-top box 11 are not explicitly shown in the figure. The set-top box of FIG. 1 advantageously provides a two-way communications capability between a service provider and the customer's premises.

In operation of the illustrative set-top box of FIG. 1, the customer (in whose premises set-top box 11 is located), may report to the service provider an indication of degraded video quality in the video content being received by the set-top box, simply by pressing video quality problem reporting button 14. In accordance with some illustrative embodiments of the present invention, video quality problem reporting button 14 may be further employed to provide more specific information regarding the video quality problem, and/or may be used in an interactive process to further define the nature of the video quality problem.

For example, the customer may use video quality problem reporting button 14 to report to the service provider not only the fact of a problem with the video quality, but also a (subjective) measure of the severity of video quality degradation being experienced. This may, for example, be reported by pressing the button a given number of times (e.g., from a minimum number of one to a maximum number, such as, for example, three) based on the perceived severity level. Moreover, the customer may respond interactively to questions and or suggestions presented by the service provider on the video screen with various actions, which may include various pushes of video quality problem reporting button 14.

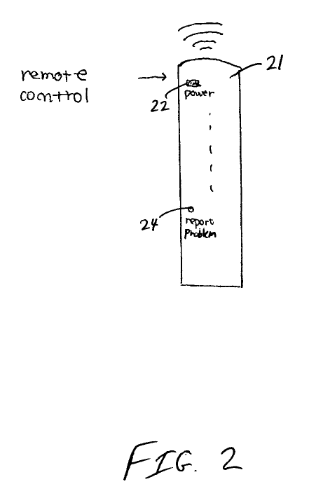

FIG. 2 shows an example of a remote control for use with a set-top box for receiving IPTV video signals and reporting video quality problems in accordance with an illustrative embodiment of the present invention. The figure shows remote control 21 having power button 22 and, in accordance with the illustrative embodiment of the present invention, video quality problem reporting button 24. Other buttons and other features which may be present on remote control 21 are not explicitly shown in the figure.

Note that the remote control of FIG. 2 may, for example, operate to control a set-top box (such as, for example, the set-top box of FIG. 1 or, alternatively, a conventional set-top box that does not have a video quality problem reporting button mounted thereon), or, it may operate to directly control a television or other video display device which has two-way communications capability between a service provider and the customer's premises, therefore having no need for a separate set-top box. As is well known to those skilled in the art, such televisions may, for example, be equipped with the capability to support the use of a “cable card.”

In operation of the illustrative remote control of FIG. 2, the customer (in whose premises a set-top box or television which is controlled by remote control 21), may report to the service provider an indication of degraded video quality in the video content being received by the set-top box, simply by pressing video quality problem reporting button 24. In accordance with some illustrative embodiments of the present invention, video quality problem reporting button 24 may be further employed to provide more specific information regarding the video quality problem, and/or may be used in an interactive process to further define the nature of the video quality problem, in similar fashion to the approaches described above in connection with the set-top box of FIG. 1.

In either of the illustrative embodiments shown in FIG. 1 or FIG. 2 (i.e., where a video quality problem reporting button is provided on a set-top box or a remote control unit), the operation of the illustrative devices (i.e., set-top box or remote control) may be supported with the use of embedded software contained within the set-top box (in the case of either FIG. 1 or FIG. 2), or, alternatively (in the case of FIG. 2 where no set-top box is provided) within a cable card. This embedded software advantageously operates to send bits of information back to the service provider, indicating the reporting of a video quality problem and/or specifying information related thereto. For example, the software may transmit to the service provider the customer's unique ID (identification) code, and, if available, an indication of the severity of video quality degradation (see above). (In other illustrative embodiments of the present invention, the above-described software may be located in whole or in part at the service provider's “head-end” rather than in the set-top box.) The implementation of such software will be obvious to those skilled in the art.

As pointed out above, in accordance with some illustrative embodiments of the present invention, an interactive process may be advantageously employed to further define the nature of the video quality problem which has been reported by the customer. For example, once the video quality problem reporting button has been pushed, a problem reporting process may be advantageously initiated in which, for example, the customer is first asked to choose between a number of possible common problems to identify the type of problem being experienced. Illustratively, the customer may be asked to choose from among:

(i) a scrambled or jerky picture;

(ii) macro blocking;

(iii) a frozen picture;

(iv) snow on all of the channels; etc.

### Then, based on the answer to this first question, a “question tree” may be traversed interactively with the user to narrow down the problem. (“Question trees” are fully familiar to those of ordinary skill in the art and are also known as “decision trees.”)

In accordance with one illustrative embodiment of the present invention, once the customer has chosen the type of the problem being experienced, the service provider may, for example, prompt the customer to indicate the severity of the problem. For example, the customer may be asked to rate the problem's severity on a scale between any two provided numbers, such as, for example, one and five, where one is defined to mean that the video signal is “merely acceptable” and five is defined to mean that the video signal is of “very poor quality.” The customer can confirm the severity of the problem report by responding appropriately to the query—such as, for example, with use of the video quality problem reporting button.

Next, in accordance with one illustrative embodiment of the present invention, the set-top box advantageously sends the information provided by the customer to the service provider's network management system, and the customer waits for an acknowledgement therefrom. The service provider's network management system may, in accordance with certain illustrative embodiments of the present invention, deduce certain causes of the customer's problem based on information provided by the customer as to the type of problem being experienced. For example, if it is identified that there is “snow” on all of the channels, it is possible that the cable or fiber optic cable line has been cut. In such a case, it may be necessary that the service provider's repair personel need to come to the customer's house to correct the problem. If, on the other hand, a scrambled picture box is identified, the problem is most likely with the customer's TV and set-top-box connection. In this case, for example, the following instructions may be given to the customer:

(i) check the TV's horizontal and vertical hold;

(ii) if the TV is connected to a VCR, try the following options:
a) Make sure the VCR is on channel 3,
b) Verify that the VCR is “fine-tuned” to channel 3,
(c) locate and adjust the fine-tuning until the picture comes in clearly,
(d) confirm that the 3/4 channel switch is in the correct position, 3; and

(iii) if a converter is connected to the TV, ensure that the TV is on channel 3.

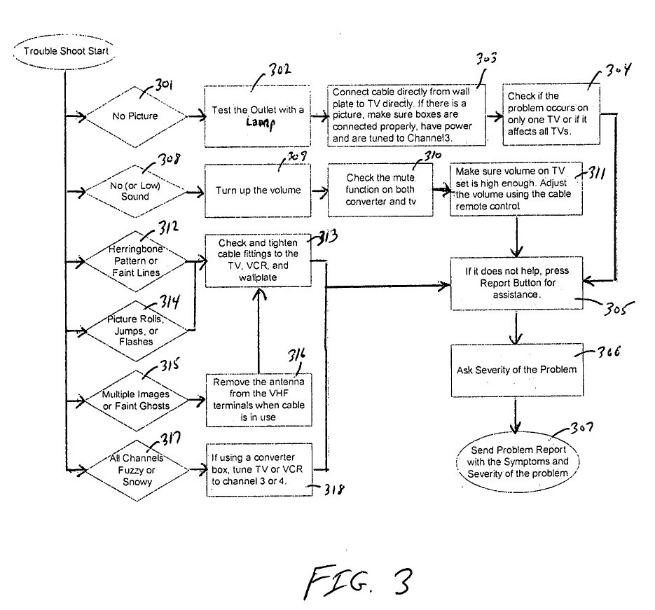

FIG. 3 shows a sample “question tree” flowchart of a method for performing video quality problem troubleshooting in accordance with an illustrative embodiment of the present invention. As pointed out above, this procedure may advantageously be implemented in software which resides, preferably, in the set-top box, but alternatively, at the headend of the service provider's network.

Specifically, as shown in the sample flowchart, decision block 301 first asks the customer whether there is any picture at all. If not, the troubleshooting procedure suggests that the customer:

(i) test the outlet with a lamp (block 302),

(ii) connect the cable directly from the wall plate to the TV and, if there is a picture, make sure the boxes are properly connected, have power and are tuned to channel 3 (block 303), and

(iii) check if the problem occurs on only one TV if it affects all TV's (block 304).

Flow then proceeds to block 305, which instructs the customer to press the video quality problem reporting button (again) if the previous procedures did not help. Then; block 306 requests that the customer indicate the severity of the problem and block 307 sends the problem report with the symptoms and the severity of the problem to the service provider's network management system.

If the customer indicated in decision block 301 that there is, in fact, a picture, decision block 308 then asks if there is no (or low) sound. If not, the troubleshooting procedure suggests that the customer:

(i) turn up the volume (block 309),

(ii) check the mute function on both the converter and the TV (block 310), and

(iii) make sure that the volume on the TV set is high enough, and adjust the volume using the cable remote control (block 311).

Flow then again proceeds to block 305, which instructs the customer to press the video quality problem reporting button (again) if the previous procedures did not help. Then, block 306 requests that the customer indicate the severity of the problem and block 307 sends the problem report with the symptoms and the severity of the problem to the service provider's network management system.

If the customer indicated in decision block 308 that there is, in fact, sound, decision block 312 then asks if there are herringbone patterns or faint lines. If so, the troubleshooting procedure suggests that the customer check and tighten cable fittings to the TV, VCR and wall plate (block 313). Flow then again proceeds to block 305, which instructs the customer to press the video quality problem reporting button (again) if the previous procedures did not help. Then, block 306 requests that the customer indicate the severity of the problem and block 307 sends the problem report with the symptoms and the severity of the problem to the service provider's network management system.

If the customer indicated in decision, block 312 that there is, in fact, no herringbone or faint line problem, decision block 314 then asks if the picture rolls, jumps or flashes. If so, the troubleshooting procedure again suggests that the customer check and tighten cable fittings to the TV, VCR and wall plate (block 313). Flow then again proceeds to block 305, which instructs the customer to press the video quality problem reporting button (again) if the previous procedures did not help. Then, block 306 requests that the customer indicate the severity of the problem and block 307 sends the problem report with the symptoms and the severity of the problem to the service provider's network management system.

If the customer indicated in decision block 314 that the picture does not, in fact, roll, jump or flash, decision block 315 then asks if there are multiple images or ghosts. If so, the troubleshooting procedure suggests that the customer remove the antenna from the VHF terminals of the TV when cable is in use (block 316). Flow then again proceeds to block 305, which instructs the customer to press the video quality problem reporting button (again) if the previous procedures did not help. Then, block 306 requests that the customer indicate the severity of the problem and block 307 sends the problem report with the symptoms and the severity of the problem to the service provider's network management system.

And finally, if the customer indicated in decision block 315 that there are no multiple images or ghosts, decision block 317 then asks if the picture on all channels is fuzzy or snowy. If so, the troubleshooting procedure suggests that, if the customer is using a converter box, that the TV or VCR be properly tuned to channel 3 or 4 (block 318). Flow then again proceeds to block 305, which instructs the customer to press the video quality problem reporting button (again) if the previous procedures did not help. Then, block 306 requests that the customer indicate the severity of the problem and block 307 sends the problem report with the symptoms and the severity of the problem to the service provider's network management system.

### Illustrative Network Problem Identification and Diagnosis Process

In accordance with the principles of the present invention and with certain illustrative embodiments thereof, a service provider may advantageously identify and diagnose a cause of the customer's video quality problem based on aggregating video quality problem reports from a plurality (or lack thereof) of its customers. In other words, if a video quality problem is reported in accordance with the principles of the present invention by a number of customers, the service provider will be able to advantageously determine that the problem is unlikely to be located at the individual customers' premises. On the other hand, if a video quality problem is reported in accordance with the principles of the present invention by a single customer only, it is more likely that the problem is either physically located at the customers' premises or otherwise associated with the given customer's individual service.

That is, by recognizing the existence of video quality problem reports from a plurality of customers, and by analyzing those customers' geographical and/or topological information within the service provider's network, the service provider may advantageously identify, locate, and potentially diagnose the source of the problem. Clearly, for example, video problems that are present at the “head-end” of the service provider's network are likely to affect all customers, while problems with the DSLAM (Digital Subscriber Line Access Multiplexer), for example, may only affect certain customers, and, in particular, customers which are located geographically near to each other. Similarly, a set-top box problem will only affect a (single) particular customer.

In fact, based on the specific set of customers reporting like or similar video quality problems, it is possible in accordance with one illustrative embodiment of the present invention to determine not only the topological location of the problem within the service provider's network, but also the physical (i.e., geographical) location of the problem as well. For example, if many customers from a given neighborhood are reporting a video quality degradation problem, but customers in other neighborhoods are not, the problem is likely to be in the portion of the service provider's network associated with the transmission and distribution of video service to that given neighborhood.

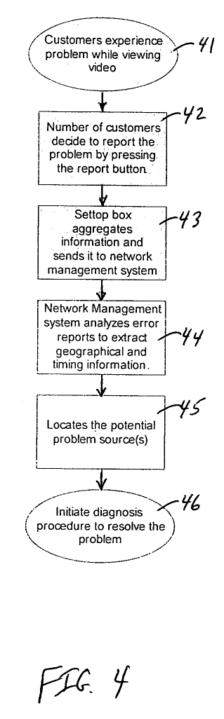

FIG. 4 shows a flowchart of a sample method for identifying and diagnosing a video network problem in accordance with an illustrative embodiment of the present invention. First, assume that some set of customers experience a video quality problem which viewing video from the service provider (as shown in block 41). Then, in accordance with the illustrative embodiments of the present invention, a number of these customers decide to report the problem by pressing the video quality reporting button on their set-top box or remote control unit (as shown in block 42).

As a result of the customers' pressing of their video quality reporting buttons, and, possibly (in accordance with certain illustrative embodiments of the present invention), the customers' performing a video quality problem troubleshooting procedure (as illustratively shown in FIG. 3, and described above), their corresponding set-top boxes transmits the problem report with any available additional information regarding the video problem to the service provider's network management system (as shown in block 43). (See also, for example, block 307 of FIG. 3.)

Then, in accordance with the principles of the present invention and with an illustrative embodiment thereof, the network management system of the service provider analyzes the received problem reports and extracts timing information associated with the received problem reports and further extracts geographical and topological information associated with the customers which sent such problem reports within a given timeframe, as well as any information regarding the type of problem being experienced by each of the given customers (as shown in block 44). In particular, the network management system of the service provider advantageously determines whether multiple problem reports having the same characteristics (i.e., of the same or similar type of problem) have been received. As pointed out above, if only a single customer has sent a problem report (of a given type of problem), then it is unlikely that the problem is located within the service provider's network. If, however, a number of customers have reported a similar type of video problem in a given timeframe, it is likely that there is a network equipment (e.g., “head-end”) problem.

Then, in accordance with an illustrative embodiment of the present invention, the network management system of the service provider advantageously uses the extracted information together with its detailed knowledge of the network topology—both topological and physical (i.e., geographical)—to locate one or more potential sources of the problem (as shown in block 45). That is, if only a single customer has sent a problem report, the (geographical) source of the problem is likely to be at the customer's premises. If, on the other hand, a number of customers have reported a similar type of video problem in a given timeframe, the network management system identifies the potential locations in the network where a problem might effect all of the customers which have reported the problem (but not others).

If, as is typical, the video network is represented with use of a conventional tree-based data structure, then this analytical procedure may, for example, be performed with use of conventional tree-based database analysis methods, which are wholly conventional and will be fully familiar to those of ordinary skill in the art. For example, given a set of customers which are experiencing a video problem, a node in the tree-structured database which has each of the reporting customers as a “descendent” node thereof is a node which is representative of a potential location in the network where a problem would be likely to effect all of the customers which have reported the problem (but not others).

Finally, once the potential locations—topological and/or geographical—have been identified, conventional diagnostic procedures, which may be automated or manual (e.g., sending repair personnel to the identified geographical location), may be instituted in an attempt to resolve the (network) problem (as shown in block 46).

### Other Illustrative Embodiments

In accordance with other illustrative embodiments of the present invention, a “virtual” button, rather than a “physical” button, may be used by a customer to report video problems and/or to perform video quality problem troubleshooting. In particular, in a manner fully familiar to those of ordinary skill in computer-related arts, video monitor screens (such as, for example, those used by personal computers) often display a “virtual” “button” which may be activated with, for example, a mouse click or, alternatively, by being highlighted (possibly with use of a keyboard's “arrow” keys) followed by the pressing of a keyboard's “enter” key. Thus, in accordance with various other illustrative embodiments of the present invention, a “virtual” button may be displayed—either on the video screen which normally displays the video content or, alternatively, on any other associated display device—and the customer may activate this “virtual” button in any conventional manner available to report a video problem and/or to perform video quality problem troubleshooting.

Although the above illustrative embodiments of the present invention operate with the use of a single, “physical” problem reporting button on a set-top box or a remote control therefor, or with use of a single “virtual” problem reporting button on a television or computer monitor screen, it will be obvious to those of ordinary skill in the art that a plurality of physical or virtual buttons may be advantageously employed on those devices to provide additional flexibility and possibly additional functionality or ease of use. Thus, in accordance with other illustrative embodiments of the present invention, a plurality of problem reporting buttons—either “physical” or “virtual” or both—may be provided.

### Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. A method for use by a video service provider for identifying a network problem in a video network used by said video service provider to transmit video signals to customers thereof, the method comprising the steps of:
(a) receiving, from one or more of said customers of said video service provider, one or more corresponding real-time on-line reports of a video quality problem with one of said video signals, the one of said video signals having been received from said service provider at one or more customer premises and the video quality problem therewith being that said one of said video signals is of insufficient quality, each of said customer premises having located thereat a video display control apparatus for receiving and displaying said video signal, the real-time on-line reports of said video quality problem each having been reported by a corresponding one of said customers with use of a user interface associated with said corresponding video display control apparatus; and
(b) identifying a topological location in said video network where a potential network problem exists based on
(i) said one or more received real-time on-line reports of said video quality problem with said one of said video signals, and
(ii) information relating said one or more of said customers to corresponding topological locations within said video network.

2. The method of claim 1 wherein said information relating said one or more of said customers to corresponding topological locations within said video network comprises a tree-based data structure representative of said video network, the tree-based data structure comprising a plurality of nodes, and wherein each of said customers of said video service provider are represented by one of said nodes of said tree-based data structure.

3. The method of claim 2 wherein said step of identifying said topological location in said video network where a potential network problem exists comprises determining a node in said tree-based data structure for which each node representative of a customer from which one of said real-time on-line reports of a video quality problem has been received is a descendent thereof.

4. The method of claim 1 wherein said information relating said one or more of said customers to corresponding topological locations within said video network further comprises geographical information associated therewith, and wherein said method further comprises determining a physical location in said video network where a potential network problem exists.

5. The method of claim 1 wherein said step of receiving each of said real-time on-line reports of a video quality problem with one of said video signals further comprises receiving diagnostic information relating thereto.

6. The method of claim 5 wherein said received diagnostic information relating to each of said real-time on-line reports of a video quality problem with one of said video signals has been generated with use of an interactive troubleshooting procedure, wherein said interactive troubleshooting procedure comprises said corresponding customer providing one or more responses to a corresponding one or more questions relating to said insufficient quality of said video signal.

7. The method of claim 6 wherein said step of identifying a topological location in said video network where a potential network problem exists is further based on said received diagnostic information relating to said received real-time on-line reports of a video quality problem.

8. The method of claim 7 wherein said step of identifying a topological location in said video network where a potential network problem exists is determined by
(i) identifying one or more of said real-time on-line reports of a video quality problem for which said related diagnostic information has one or more common characteristics therebetween, and
(ii) identifying the topological location in said video network where a potential network problem exists based on said identified real-time on-line reports of a video quality problem for which said related diagnostic information has one or more common characteristics therebetween and not on other ones of said real-time on-line reports of a video quality problem.
